(19) United States
(12) Patent Application Publication
(10) Pub. No.: US 2022/0323893 A1
(43) Pub. Date: Oct. 13, 2022

(54) COLLAPSIBLE FILTER FRAME

(71) Applicant: 3M INNOVATIVE PROPERTIES COMPANY, St. Paul, MN (US)

(72) Inventor: Chad E. Nordling, Stillwater, MN (US)

(21) Appl. No.: 17/642,349

(22) PCT Filed: Sep. 11, 2020
(86) PCT No.: PCT/IB2020/058436

§ 371 Date: Mar. 11, 2022

Related U.S. Application Data
(60) Provisional application No. 62/900,842, filed on Sep. 16, 2019.

(51) Int. Cl. B01D 46/00; B01D 46/12

(52) U.S. Cl. CPC B01D 46/0016; B01D 46/12; B01D 46/0005

(57) ABSTRACT

Collapsible filter frames are described. In particular, collapsible filter frames including at least one top frame portion, at least one bottom frame portion, and at least one joint between the at least one top frame portion and the at least one bottom frame portion are described. The collapsible filter frame is configured to receive a filter media insert, the insertion of which renders the collapsible frame temporarily non-collapsible.

### BACKGROUND

Filter frames are used to hold filter media in place and/or to install the filter media in position within an exhaust hood, a HVAC system, or the like. Such frames may be used in industrial, commercial, and residential settings.

### SUMMARY

In one aspect, the present description relates to a collapsible filter frame. The collapsible filter frame includes at least one top frame portion, at least one bottom frame portion, and at least one joint between the at least one top frame portion and the at least one bottom frame portion. The collapsible filter frame is configured to receive a filter media insert, the insertion of such filter media insert making the collapsible filter frame temporarily non-collapsible.

### BRIEF DESCRIPTION OF THE DRAWINGS

FIG. 1 is a front perspective view of a collapsible filter frame.

FIG. 2 is a front perspective view of another embodiment of a collapsible filter frame.

FIG. 3 is a schematic side elevation cross-section showing a filter media insert disposed in a collapsible filter frame.

### DETAILED DESCRIPTION

Filter frames hold filter media in place and/or install the filter media in position so that it can perform its desired function. In some embodiments, the filter media and filter frame (i.e., the filter assembly) is designed to be used to an exhaust hood system. In some embodiments, the filter frame provides structural rigidity to the filter assembly. In some embodiments, the filter frame allows for insertion or attachment of the filter assembly to a permanent mounting system, without having to rely on the filter media itself for such attachment.

In some embodiments, the filter assembly may be configured for general air filtering purposes; for example, in a room air filtering system, a furnace filtering system, or another forced air filter system. In these embodiments, the filter frame and filter media are configured such that the filter primarily filters airborne particulates. For example, the filter media may be designed to filter particles smaller than 10 micrometers in diameter, smaller than 5 micrometers in diameter, 2.5 micrometers, or 0.3 micrometers in diameter. In some embodiments, the filter assembly may be used for a specialized purpose, such as in a commercial kitchen, for grease filtering purposes.

In commercial kitchens, grease capture in exhaust hoods may be important for health, safety, and environmental reasons. Grease buildup in and around an exhaust hood or the ducting in airflow communication with the exhaust hood may pose a fire hazard, the grease deposits being highly flammable. Exacerbating the danger, commercial exhaust hoods are configured to accommodate a large volume of air traveling through them, which can magnify the hazard should a fire start.

Counterintuitively, because rigidity and structural integrity of the filter assembly may be critical to the usefulness, safety, and efficacy of a filter assembly within a duct or hood system, collapsible filter frames may provide a valuable safety feature. For example, in applications where the filter media performs a critical function, such as filtration of harmful particulates or as a flame barrier, it is equally critical that a filter assembly is never installed without the filter media accidentally. In such cases—and especially where the mounting mechanism requires only clips, connectors, or flanges disposed on the filter frame—it may be difficult to tell that a filter assembly is missing its filter media, since the empty filter assembly can be installed successfully. However, if a frame is collapsible—and particularly if a frame is collapsible if and only if the correct filter media is not installed within such a frame, it is more difficult to incorrectly install the filter assembly without its critical filter media component: it is either impossible to secure the frame without the filter media or the collapsed filter frame provides a conspicuous visual cue.

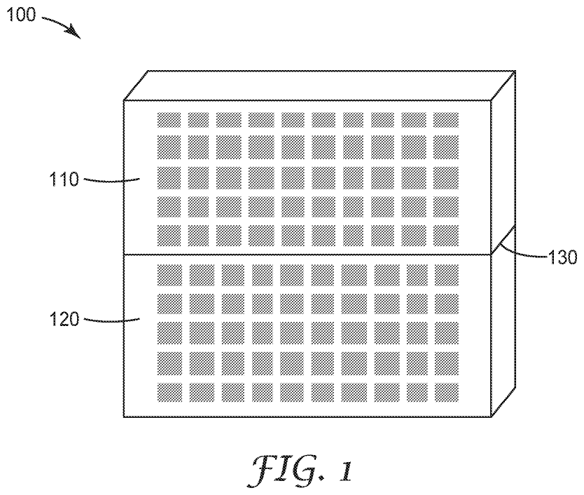

FIG. 1 is a front perspective view of a collapsible frame. Collapsible filter frame 100 includes top frame portion 110 and bottom frame portion 120, with joint 130 between them. In some embodiments, top frame portion 110 and bottom frame portion 120 are made of the same material. In some embodiments, the top and bottom frame portions are symmetrical. In some embodiments, the top and bottom frame portions are the same size. In some embodiments, one or more of the top and bottom frame portions include a marking, fiducial, or some other visual indication to distinguish the two sides and/or allow for installation the right way up.

In some embodiments, the top and bottom portions of the frame are formed from a metal or metal alloy. In some embodiments, the top and bottom portions are made from an aluminum or aluminum alloy. In some embodiments, the top and bottom portions of the frame may be formed from or may include a polymeric material, or may be formed from or include a wood or a wood pulp material. Polymeric materials may be injection moldable or compatible with an additive manufacturing process. Lightweight woods such as a balsa wood or cork wood may be used. Manufactured wood products such as particleboard, fiberboard, or chipboard may be particularly appropriate. In some embodiments, wood pulp materials such as cardboard, paperboard, and the like may be used. In some embodiments, carbon fiber, fiberglass, or composite materials may be used. In some embodiments, these materials are either inherently fire-retardant or are surrounded or coated with a metallic layer (for example, a metal foil-wrapped frame). In some embodiments, the top and bottom portions of the frame may be coated with a fire- or flame-retardant coating.

Joint 130 is where top frame portion 110 and bottom frame portion 120 meet. In some embodiments, joint 130 is a physical gap that separates the top and bottom frame portions. In some embodiments, joint 130 is a hinge that attaches the top and bottom frame portions, but allows the two portions to rotate relative to each other. In some embodiments, joint 130 is some other interlocking mechanism that permits the two sides to be securely attached, but allows the two portions to rotate relative to each other. Joint 130 may include a magnetic or physical interlocking mechanism to guide or position the top and bottom frame portions relative to one another. In some embodiments, joint 130 is a combination of several styles; for example, both a hinge and a physical gap.

Joint 130 may be configured to allow collapsible filter frame 100 to collapse inwards (i.e., from the perspective of FIG. 1, into the page), outwards (i.e., from the perspective for FIG. 1, out of the page), or both outwards and inwards. Joint 130 may include any appropriate physical mechanism to prevent the filter frame from collapsing one way or the other.

Both top frame portion 110 and bottom frame portion 120 may be any suitable shape or size, and, accordingly, joint 130 may take any shape or form. In some embodiments, the top and bottom frame portions may have a substantial portion of open area to allow air to pass through the frame. In some embodiments, more than 50% of the top or bottom frame portions may be open area, as viewed from a top plan view. In some embodiments, more than 70% or more than 80% may be open area. The top and bottom frame portions may include an aesthetically pleasing pattern or design and may have a visually interesting three-dimensional shape (i.e., not flat). While FIG. 1 depicts a substantially regular design, the design of the open area in the top and bottom frame portions may vary in a periodic or non-periodic manner. Although joint 130 is depicted in FIG. 1 as substantially horizontally bisecting collapsible filter frame 100, the joint seam may be straight, curved, made up of angled straight segments (e.g., a sawtooth), or any combination thereof.

Collapsible filter frame 100 may include any additional hardware or other mechanisms to allow or facilitate installation into the desired application. For example, if collapsible filter frame 100 is designed to be installed into a range hood, collapsible filter frame 100 may include handles to lift the frame into position and/or clips to attach or secure the frame in the correct location.

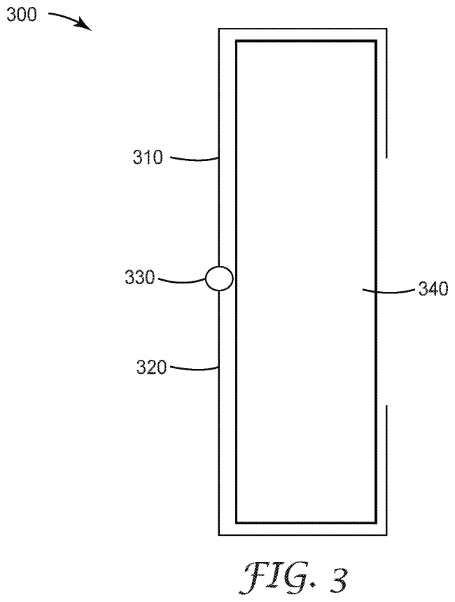

In some embodiments, collapsible filter frame 100 may be no longer collapsible when filled with the correct filter media insert. FIG. 3 is a schematic side elevation cross-section showing a filter media insert disposed in a collapsible filter frame. Top frame portion 310 and bottom frame portion 320 are joined by joint 330, which is represented as a hinge mechanism in this embodiment. Filter media insert 340 is disposed within the volume of the top and bottom frame portions. Filter media insert 340 may slide into or be snapped into place within the collapsible filter frame.

Filter media insert 340 is rigid, at least to the extent necessary to resist the collapsing of the top and bottom frame portions of the collapsible filter frame. Filter media insert 340 need not be a rigid material (e.g., a metal), but may have an overall construction stiff enough to prevent the collapsible filter frame from collapsing. For example, a typical box filter with a polymeric, non-woven filter media within a paperboard frame may have sufficient stiffness to prevent collapse when provided within the collapsible filter frame. Note that the filter media itself need not possess rigidity or stiffness, and the stiffness of the insert as a whole (i.e., including any frame) is the relevant property.

Filter media insert 340 may be any suitable size and shape, but in many embodiments will have dimensions to roughly fill the space within the filter frame. The filter media insert may include any suitable filter media material, such as non-woven polymeric filter media, fire-resistant oxidized polyacrylonitrile non-woven material, woven fire-retardant materials such as wool, non-woven or woven webs of metal fibers, ceramic fibers, fiberglass, FR rayon, modacrylic, basalt, and combinations and blends thereof. In some embodiments, the filter media may include a metal mesh. In some embodiments, the filter media insert may include multiple layers of filter media. In some embodiments, the filter media may include pleated material, or may be charged or include electrets to increase its filtration efficiency.

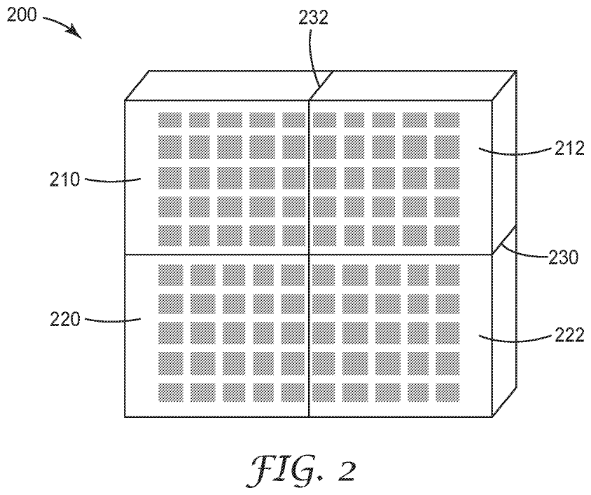

FIG. 2 is a front perspective view of another embodiment of a collapsible filter frame. Collapsible filter frame 200 included top left frame portion 210, top right frame portion 212, bottom left frame portion 220, and bottom right frame portion 222. First joint 230 and second joint 232 join the top and bottom portions, and the left and right portions, respectively.

Collapsible filter frame 200 differs from collapsible filter frame in that it includes two joint, and the frame is split into quadrants. This configuration may allow the filter frame to collapse if it is incorrectly installed (i.e., without a proper filter media insert) and also rotated incorrectly when mounted. First joint 230 and second joint 232 may be any combination of joints or joining mechanisms as described in conjunction with joint 130 in FIG. 1. While collapsible filter frame 200 depicts two joints, any number of frame portions and joints may be used, limited only by the desired application (and the overall appearance of the collapsible filter frame).

Terms such as a “top” and “bottom” are for reference purposes only and are based on the perspectives chosen to illustrate the selected embodiments. In some embodiments, “top” may correspond to a more global “top” based on the mounting mechanism for the hood or duct, when properly installed. In some embodiments, however, “top” and “bottom” may be interchangeable if the filter frame is able to be correctly installed in either orientation.

What is claimed is:

1. A collapsible filter frame, comprising:
at least one top frame portion, at least one bottom frame portion, and at least one joint between the at least one top frame portion and the at least one bottom frame portion;
wherein the collapsible filter frame is configured to receive a filter media insert, the insertion of such filter media insert making the collapsible filter frame temporarily non-collapsible.

2. The collapsible filter frame of claim 1, wherein the joint includes a hinge.

3. The collapsible filter frame of claim 1, wherein the joint includes a physical gap.

4. The collapsible filter frame of claim 1, wherein the collapsible filter frame includes, from a top plan view, at least 50% open area.

5. The collapsible filter frame of claim 1, wherein the collapsible filter frame includes, from a top plan view, at least 70% open area.

6. The collapsible filter frame of claim 1, wherein the collapsible filter frame includes metal.

7. The collapsible filter frame of claim 1, wherein the collapsible filter frame includes a metal-coated wood pulp material.

8. The collapsible filter frame of claim 1, wherein the collapsible filter frame includes a metal-coated polymeric material.

9. The collapsible filter frame of claim 1, wherein the collapsible filter frame includes a fire-retardant coating.

10. The collapsible filter frame of claim 1, wherein the collapsible filter frame includes handles.

11. The collapsible filter frame of claim 1, wherein the collapsible filter frame includes clips.

12. The collapsible filter frame of claim 1, wherein the filter frame further includes a second top portion and a second bottom portion, and a second joint between the at least one top portion and the second top portion.

13. The collapsible filter frame of claim 1, wherein the insertion of the filter media insert limits the mobility of the joint.

14. The collapsible filter frame of claim 1, wherein the insertion of the filter media insert limits rotation between the portions of the filter frame.

15. The collapsible filter frame of claim 1, wherein the insertion of the filter media holds the portions of the filter frame fixed relative to one another.
